(19) United States
(12) Patent Application Publication
(10) Pub. No.: US 2025/0321751 A1
(43) Pub. Date: Oct. 16, 2025

(54) METHOD FOR CREATING POD INSTANCES IN FEDERATED CLUSTER, DEVICE AND MEDIUM

(71) Applicant: Jingdong Technology Information Technology Co., Ltd., Beijing (CN)

(72) Inventor: Xiaofei Wang, Beijing (CN)

(73) Assignee: Jingdong Technology Information Technology Co., Ltd., Beijing (CN)

(21) Appl. No.: 18/959,215

(22) Filed: Nov. 25, 2024

(30) Foreign Application Priority Data
Apr. 12, 2024 (CN) 202410445205.4

(51) Int. Cl. G06F 9/445; G06F 18/241

(52) U.S. Cl. CPC G06F 9/44505; G06F 18/241

(57) ABSTRACT

A method and an apparatus for creating pod instances in a federated cluster includes: acquiring application configuration information of a target application, and determining an instance requirement number of the target application according to the application configuration information; selecting at least two sub-clusters from sub-clusters included in the federated cluster, and determining an instance allocation number of each of the at least two sub-clusters according to the instance requirement number; creating a controller for each of the at least two sub-clusters, and configuring an instance identifier for a controller of a corresponding sub-cluster according to the instance requirement number and the instance allocation number of each of the at least two sub-clusters, where instance identifiers configured for controllers of different sub-clusters are different; and creating a pod instance in the corresponding sub-cluster by using the controller according to configured instance identifiers.

### CROSS-REFERENCE TO RELATED APPLICATION

This application claims priority to Chinese Patent Application No. 202410445205.4 filed Apr. 12, 2024, the disclosure of which is incorporated herein by reference in its entirety.

### TECHNICAL FIELD

Embodiments of this disclosure relate to the field of federated cluster control technology, and in particular, to a method and an apparatus for creating pod instances in a federated cluster, and a device and a medium.

### BACKGROUND

Applications deployed in a containerized application cluster can be divided into stateful applications and stateless applications. Instances of stateful applications generally have dependencies therebetween, so instances of stateful applications require exclusive instance identifiers. When stateful applications are to be deployed or run, the stateful applications are required to be deployed or run in sequence according to instance identifiers in a defined order.

When deploying stateful applications in a single containerized application cluster, a controller can be used to create container group pod instances for the deployment of the stateful applications, the controller can be used to assign a unique instance identifier (such as a sequence number) to the pod instance created by the controller, and the sequence number assignment generally starts from 0.

In the process of implementing the present disclosure, the inventors found that when stateful applications are scaled for deployment in a federated cluster (i.e., a cluster obtained by federating multiple containerized application clusters), instance IDs assigned by each controller to the pod instances under its name start from 0, which results in the pod instances in different containerized application clusters having the same instance ID, making it impossible to control the deployment or running of the applications according to the instance IDs in a defined order.

### SUMMARY

A method and an apparatus for creating pod instances in a federated cluster, a device, and a medium are provided according to embodiments of the present disclosure, which can prevent pod instances in different sub-clusters from having the same instance ID, thereby ensuring that the applications can be deployed or run in a defined order.

In a first aspect, a method for creating container group pod instances in a federated cluster is provided according to embodiments of the present disclosure, which includes:
acquiring application configuration information of a target application, and determining an instance requirement number of the target application according to the application configuration information;
selecting at least two sub-clusters from sub-clusters included in the federated cluster, and determining an instance allocation number of each of the at least two sub-clusters according to the instance requirement number;
creating a controller for each of the at least two sub-clusters, and configuring an instance identifier for a controller of a corresponding sub-cluster according to the instance requirement number and the instance allocation number of each of the at least two sub-clusters, where instance identifiers configured for controllers of different sub-clusters are different; and
creating a pod instance in the corresponding sub-cluster by using the controller according to configured instance identifiers.

In a second aspect, an electronic device according to embodiments of the present disclosure includes a memory, a processor, and a computer program stored in the memory and executable on the processor. The processor, when executing the program, implements the method for creating container group pod instances in a federated cluster as described in any embodiment of the present disclosure.

In a third aspect, a computer-readable storage medium according to embodiments of the present disclosure stores a computer program. The computer program, when being executed by a processor, implements a method for creating container group pod instances in a federated cluster as described in any embodiment of the present disclosure.

In the solution of the embodiments of the present disclosure, application configuration information of a target application may be acquired, and an instance requirement number of the target application may be determined according to the application configuration information; at least two sub-clusters may be selected from sub-clusters included in the federated cluster, and an instance allocation number of each of the at least two sub-clusters may be determined according to the instance requirement number; a controller may be created for each of the at least two sub-clusters, and at least one instance identifier may be configured for the controller of the corresponding sub-cluster according to the instance requirement number and the instance allocation number of each of the at least two sub-clusters, where instance identifiers configured for controllers of different sub-clusters are different; and a pod instance may be created in the corresponding sub-cluster by using the controller according to the configured at least one instance identifier. According to the present disclosure, in creating a controller for each sub-cluster, at least one instance identifier can be configured for the controller of the corresponding sub-cluster according to the instance requirement number of the application and the instance allocation number of each sub-cluster, that is, configuring an instance identifier for the controller of each sub-cluster from a global perspective to ensure that different instance identifiers are configured for the controllers of different sub-clusters. In this way, when the controller is used to create a pod instance in the corresponding sub-cluster, the instance identifier of the pod instance will fall within the range of the at least one instance identifier configured for the corresponding controller, so that the pod instances in different sub-clusters can be ensured to have different instance identifiers, which avoids the pod instances in different sub-clusters having the same instance identifier, and ensures that the application can be deployed or run in a defined order according to the instance identifiers.

In addition, at least two sub-clusters are selected from the sub-clusters included in the federated cluster in real time and the instance allocation number of each sub-cluster is determined, which can enhance the flexibility of application deployment or running and improve cluster resource utilization; and by configuring different instance identifiers for the controllers of different sub-clusters, it is ensured that the pod instances in different sub-clusters have different instance identifiers, which avoids the pod instances in different sub-clusters having the same instance identifier, and since it simply requires to make configuration for the controllers, the management and operation and maintenance of application instances in the federated cluster can be simplified.

### BRIEF DESCRIPTION OF DRAWINGS

In order to more clearly illustrate the technical solution of the present disclosure, the drawings required for use in the embodiments are briefly introduced below. It should be understood that the following drawings only illustrate certain embodiments of the present disclosure and should not be regarded as limiting the scope. For the person of ordinary skills in the art, other relevant drawings can be obtained based on these drawings without making creative efforts.

FIG. 1 is a schematic flowchart of a method for creating pod instances in a federated cluster according to an embodiment of the present disclosure;

FIG. 2 is another schematic flowchart of a method for creating pod instances in a federated cluster according to an embodiment of the present disclosure;

FIG. 3 is still another schematic flowchart of a method for creating pod instances in a federated cluster according to an embodiment of the present disclosure;

FIG. 4 is an example diagram of a conventional method for creating pod instances in a federated cluster;

FIG. 5 is an example diagram of a method for creating pod instances in a federated cluster according to an embodiment of the present disclosure;

FIG. 6 is a schematic structural diagram of an apparatus for creating pod instances in a federated cluster according to an embodiment of the present disclosure; and

FIG. 7 is a schematic structural diagram of an electronic device according to an embodiment of the present disclosure.

### DETAILED DESCRIPTION

It should be noted that the terms “first”, “second”, etc. in the specification and claims of the present disclosure and the above drawings are intended to distinguish similar objects, and are not necessarily used to describe a specific order or sequence. It should be understood that the data used in this way can be interchangeable where appropriate, so that the embodiments of the present disclosure described here can be implemented in an order other than those illustrated or described here. In addition, the terms “including” and “having” and any variations thereof are intended to cover non-exclusive inclusions. For example, a process, method, system, product or device that includes a series of steps or units is not necessarily limited to those steps or units explicitly listed, but may include other steps or units that are not explicitly listed or inherent to the process, method, product or device.

For ease of understanding, the following are the relevant concepts involved in the embodiments of the present disclosure.

A containerized application cluster is a set of computing resources consisting of a group of physical or virtual machines, which are uniformly managed and orchestrated through a container orchestration platform. A containerized application cluster generally consists of one control plane node and multiple data plane nodes. The control plane node is responsible for managing and controlling the entire cluster, while the data plane nodes are the practical computing nodes that run the containerized applications.

A container orchestration platform is used to automate, scale, and manage containerized applications. The container orchestration platform provides a platform that allows multiple servers to host the same application to achieve high availability. In simple terms, the container orchestration platform can be considered as a system or tool for container orchestration, and a containerized application cluster is a cluster of servers managed by the container orchestration platform.

A container orchestration platform management system is a platform that combines multiple containerized application clusters (i.e., a federated cluster) for unified management. The container orchestration platform management system provides functions such as cross-cluster service orchestration, application management and resource scheduling, which can help developers and operation and maintenance personnel better manage and utilize multi-cluster environment.

Stateful applications are applications where instances have dependencies between each other or where instances have dependencies on external data. For example, a certain application instance must be started before other application instances, otherwise other application instances will not be able to start. Stateful applications require stable persistent storage and exclusive instance identifiers. Typical stateful applications include applications, for example, database applications and message queue applications. When stateful applications are to be deployed in a containerized application cluster, the stateful application controller (for example, StatefulSet, abbreviated as STS) provided by the container orchestration platform can be used for implementation. StatefulSet is a stateful resource object that implements stateful deployment of applications by using ordered instance naming and persistent storage. When stateful applications need to be scaled, reduced, or rolling-updated, StatefulSet can ensure the order and uniqueness of application instances, thereby ensuring data consistency and reliability.

Stateless applications are applications where instances have no dependencies between each other and do not require stable persistent storage and exclusive instance identifiers. That is, instances of stateless applications can share instance identifiers. Typical stateless applications include applications, for example, interface services and load balancers. When stateless applications are to be deployed in a containerized application cluster, the stateless deployment controller (for example, Deployment) provided by the container orchestration platform can be used for implementation. Deployment is a stateless resource object. Statelessness means that there is no dependency between application instances. Each instance is an independent entity that can be created, deleted, and replaced according to requirements, thereby achieving horizontal scaling and rolling updates of applications.

In a container group pod, pod can contain one or more closely related containers, these containers share the same set of network namespace, storage volume, and other resources, and can easily communicate and share data. A pod can be considered as a “sandbox” for container running.

In a containerized application cluster, an application or a component of an application can generally be deployed in a pod. For example, a web service can be deployed in a pod, while its corresponding database service can be deployed in another pod. Pod is the basic unit for deploying applications, and applications are the practical business carriers. Instances of an application run in at least one pod. A Pod instance refers to the instantiation of a pod object, which is a specific running instance of a pod.

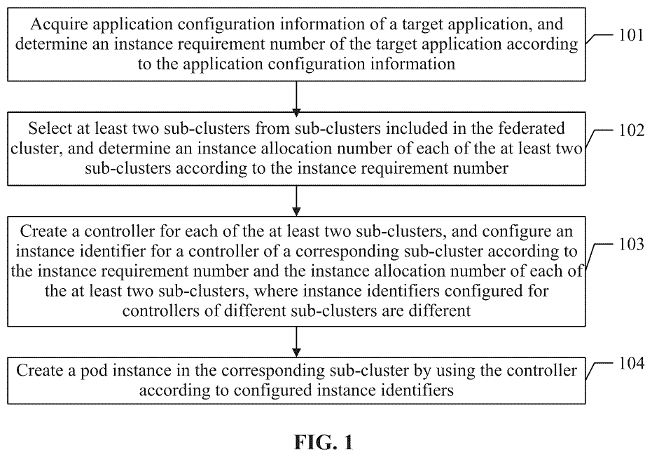

The technical solution of the embodiment of the present disclosure is introduced below. FIG. 1 is a flowchart of a method for creating pod instances in a federated cluster according to the embodiment of the present disclosure. The method for creating pod instances according to the embodiment of the present disclosure can be used in the scenario of deploying or running stateful applications in a federated cluster. The method for creating pod instances can be performed by the apparatus for creating pod instances in a federated cluster according to the embodiment of the present disclosure. The apparatus for creating pod instances can be implemented in software and/or hardware. In an embodiment, the apparatus can be integrated into an electronic device. The electronic device can be, for example, a computer, a server, etc. The electronic device can be installed with a container orchestration platform management system. The container orchestration platform management system allows application developers to use multiple containerized application clusters like using a single containerized application cluster. The following embodiment is explained by taking the apparatus integrated into an electronic device as an example. Referring to FIG. 1, the embodiment will be specifically explained from the following steps: 101 to 104.

In step 101, application configuration information of a target application may be acquired, and an instance requirement number of (that is, the number of instances required by) the target application may be determined according to the application configuration information.

The target application can be an application that needs to be deployed or run in a federated cluster. The target application is a stateful application. Instances of stateful applications are generally not equal, and generally have a dependency relationship therebetween. For example, a certain application instance must be started before other application instances, otherwise other application instances will not be able to start. Common stateful applications include applications such as database applications and message queue applications.

The application configuration information of the target application can come from the interactive interface of the federated cluster, that is, the application configuration information manually uploaded or set can be obtained from the interactive interface of the federated cluster. The application configuration information can exist in the form of a resource configuration list. The application configuration information describes the configuration information of the controller objects of the target application. The application configuration information may include:
application programming interface (API) version, that is, the version of the container orchestration platform API;
resource type and version, specifically, the target application is a stateful application, the resource type here is a stateful application controller StatefulSet, StatefulSet may have different versions, and the functions provided by different versions of StatefulSet may differ;
metadata of the controller objects, specifically, metadata may include the names of the controller objects, the namespaces where the controller objects are located, the labels, etc.;
specification of the controller objects, specifically, the specification can be used to define the specific behavior of the controller objects, the specification may include the number of instances required by the target application, a label selector for selecting the container group pod instance managed by the controller, a pod template, a storage volume declaration template, etc. The pod template may include the pod specification, a container image to be deployed or run, and the environment variables and port information required to be configured for deploying or running the container image.

Specifically, the application configuration information can be parsed to obtain the specification of the controller objects, and the instance requirement number of the target application can be determined according to the specification of the controller objects, that is, the instance number defined in the specification of the controller objects is determined as the instance requirement number of the target application. The target application generally requires multiple instances to achieve load balancing, fault tolerance, high availability, elastic scaling, etc.

In step 102, at least two sub-clusters may be selected from sub-clusters included in the federated cluster, and an instance allocation number of (that is, the number of instances allocated to) each of the at least two sub-clusters may be determined according to the instance requirement number.

The sub-clusters in the federated cluster can be containerized application clusters, that is, the federated cluster is a cluster composed of multiple containerized application clusters. At least two sub-clusters can be selected from the sub-clusters according to the practical requirements of the target application and the characteristics or status of each sub-cluster. The practical requirements of the target application may include computing resource requirements, storage resource requirements, network delay requirements, etc., and the characteristics or status of each sub-cluster may include the cluster load, resource utilization, network delay, storage capacity, etc.

Specifically, the selection of sub-clusters may include two stages: pre-selection and optimized selection. In the pre-selection stage, a group of sub-clusters can be preliminarily selected from the sub-clusters based on the practical requirements of the target application and the status of each sub-cluster. The number of sub-clusters selected in this stage may be relatively large. In the optimized selection stage, each pre-selected sub-cluster can be scored based on multiple factors (such as resource utilization, capacity, network delay, etc.), and the pre-selected sub-clusters can be ranked according to the scoring results. At least two sub-clusters can be selected from the pre-selected sub-clusters according to the ranking result. The method of pre-selection+optimized selection can be used to select sub-clusters, which can gradually narrow the selection range, improve the selection efficiency, and achieve accurate selection.

For example, there are four sub-clusters A, B, C, and D. The sub-clusters A and B both have relatively sufficient computing resources but high network latency; the sub-cluster C is medium in terms of computing resources and network latency; the sub-cluster D has the least computing resources and the lowest network latency. If the target application has a high requirement for computing resources and is highly adaptable to network latency, then the sub-clusters A, B, and C can be selected in the pre-selection stage; in the optimized selection stage, since the sub-clusters A and B have more abundant computing resources, the sub-clusters A and B will eventually be selected to deploy the target application.

Since the target application generally requires multiple instances and multiple sub-clusters are selected, it is necessary to allocate the instance requirements to the selected sub-clusters. The specific allocation method may depend on practical requirements, for example, average allocation, random allocation, weight shuffling allocation, etc. may be adopted, which is not specifically limited here.

In step 103, a controller may be created for each of the at least two sub-clusters, and an instance identifier may be configured for the controller of the corresponding sub-cluster according to the instance requirement number and the instance allocation number of each of the at least two sub-clusters, where instance identifiers configured for controllers of different sub-clusters are different.

Since the target application is a stateful application, a stateful application controller (i.e., StatefulSet) can be created for each selected sub-cluster. Specifically, the command line tool provided by the container orchestration platform can be called to create a stateful application controller for each sub-cluster based on the application configuration file. One sub-cluster corresponds to one stateful application controller, and each stateful application controller manages the resources and instances of the corresponding sub-cluster.

The at least one instance identifier configured for the controller can be used to indicate or constrain the setting method or setting range of the identifier of the instance managed by the controller. The namespace or identifier range of the instance managed by the corresponding controller can be determined according to the instance requirement number and the instance allocation number of each sub-cluster. The instance identifier is configured for the controller according to the namespace or identifier range of the instance managed by each controller. The instance identifier configured for the controller can be an instance range identifier, an instance identifier set, an instance start identifier, an instance end identifier, etc.

For example, the sub-cluster A and the sub-cluster B are selected from the sub-clusters of the federated cluster, the instance requirement number is five, the instance allocation number of the sub-cluster A is two, and the instance allocation number of the sub-cluster B is three. Then, the instance identifiers configured for the controller of the sub-cluster A can be the instance range identifier Pod-0˜Pod-1, the instance identifier set [Pod-0, Pod-1], the instance start identifier Pod-0 or the instance end identifier Pod-1, and the instance identifier configured for the controller of the sub-cluster B can be the instance range identifier Pod-2˜Pod-4, the instance identifier set [Pod-2, Pod-3, Pod-4], the instance start identifier Pod-2 or the instance end identifier Pod-4.

In step 104, a pod instance may be created in the corresponding sub-cluster by using the controller according to the configured instance identifiers.

Specifically, the controller can query the specification of the controller objects in the application configuration information to obtain the pod template. The controller can create a pod instance in the corresponding sub-cluster according to the pod template, and use the instance identifier owned by the controller itself to name the created pod instance.

Continuing with the previous example, the controller of the sub-cluster A can create two pod instances and name the two pod instances Pod-0 and Pod-1, and the controller of the sub-cluster B can create three pod instances and name the three pod instances Pod-2, Pod-3 and Pod-4.

In the solution of this embodiment, application configuration information of a target application may be acquired, and an instance requirement number of the target application may be determined according to the application configuration information; at least two sub-clusters may be selected from sub-clusters included in the federated cluster, and an instance allocation number of each of the at least two sub-clusters may be determined according to the instance requirement number; a controller may be created for each of the at least two sub-clusters, and at least one instance identifier may be configured for the controller of the corresponding sub-cluster according to the instance requirement number and the instance allocation number of each of the at least two sub-clusters, where instance identifiers configured for controllers of different sub-clusters are different; and a pod instance may be created in the corresponding sub-cluster by using the controller according to the configured at least one instance identifier. According to the present disclosure, in creating a controller for each sub-cluster, at least one instance identifier can be configured for the controller of the corresponding sub-cluster according to the instance requirement number of the application and the instance allocation number of each sub-cluster, that is, configuring an instance identifier for the controller of each sub-cluster from a global perspective to ensure that different instance identifiers are configured for the controllers of different sub-clusters. In this way, when the controller is used to create a pod instance in the corresponding sub-cluster, the instance identifier of the pod instance will fall within the range of the at least one instance identifier configured for the corresponding controller, so that the pod instances in different sub-clusters can be ensured to have different instance identifiers, which avoids the pod instances in different sub-clusters having the same instance identifier, and ensures that the application can be deployed or run in a defined order.

In addition, at least two sub-clusters are selected from the sub-clusters included in the federated cluster in real time and the instance allocation number of each sub-cluster is determined, which can enhance the flexibility of application deployment or running and improve cluster resource utilization; and by configuring different instance identifiers for the controllers of different sub-clusters, it is ensured that the pod instances in different sub-clusters have different instance identifiers, which avoids the pod instances in different sub-clusters having the same instance identifier, and since it simply requires to make configuration for the controllers, the management and operation and maintenance of application instances in the federated cluster can be simplified.

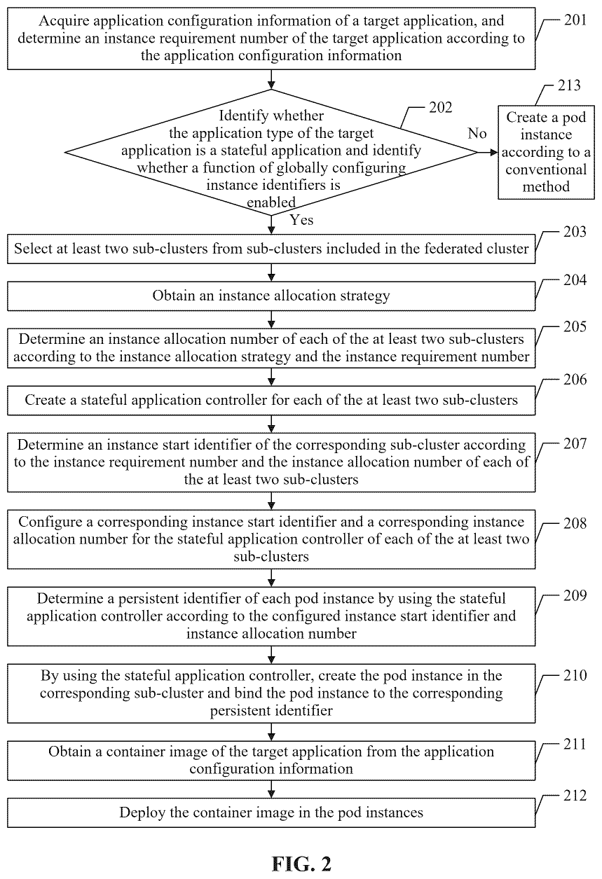

The method for creating pod instances in a federated cluster according to an embodiment of the present disclosure is further described below. As shown in FIG. 2, the method of this embodiment may include the following steps: 201 to 213.

In step 201, application configuration information of a target application is acquired, and an instance requirement number of the target application is determined according to the application configuration information.

The target application may be an application that is required to be deployed or run in the federated cluster, and the target application is a stateful application. The application configuration information may be parsed to obtain the specification of the controller objects, and the instance requirement number of the target application may be determined according to the specification of the controller objects, that is, the number of instances defined in the specification of the controller objects is determined as the instance requirement number of the target application. The target application generally requires multiple instances.

In step 202, it is identified whether the application type of the target application is a stateful application, and identified whether a function of globally configuring instance identifiers is enabled, and if so, perform step 203, otherwise, perform step 213.

Specifically, the application configuration information can be parsed to obtain the resource type. If the resource type is StatefulSet, the application type of the target application is determined to be a stateful application, because StatefulSet is a stateful application controller; and if the resource type is not StatefulSet (for example, is Deployment), the application type of the target application is determined to be a stateless application.

Since StatefulSet may have different versions, the functions provided by different versions of StatefulSet may be different. For example, some versions of StatefulSet may not have the function of globally configuring instance identifiers (for example, the StatefulSet does not have the instance start identifier control field), while some versions of StatefulSet have the function of globally configuring instance identifiers (for example, the StatefulSet has the instance start identifier control field). Therefore, after the resource type is determined to be StatefulSet, it can be determined whether the version of StatefulSet is a designated version, that is, a version with the function of globally configuring instance identifiers. After it is determined that the version of StatefulSet is the designated version, that is, it is determined that StatefulSet has the function of globally configuring instance identifiers, it can further identify whether the function of globally configuring instance identifiers of StatefulSet is enabled. The function of globally configuring instance identifiers of StatefulSet can be manually determined whether to be enabled according to practical requirements. If it is identified that the function of globally configuring instance identifiers of StatefulSet is enabled, it is required to create a pod instance in the federated cluster according to the method provided in the embodiment of the present disclosure. On the contrary, if at least one of the following occurs that the application type of the target application is a stateless application, the version of StatefulSet is not the designated version, and the function of globally configuring instance identifiers of StatefulSet is not enabled, a pod instance is created in the federated cluster according to the conventional method.

In step 203, at least two sub-clusters are selected from sub-clusters included in the federated cluster.

At least two sub-clusters can be selected from the sub-clusters according to the practical requirements of the target application and the characteristics or status of each sub-cluster. The practical requirements of the target application may include computing resource requirements, storage resource requirements, network delay requirements, etc., and the characteristics or status of each sub-cluster may include the cluster load, resource utilization, network delay, storage capacity, etc.

In step 204, an instance allocation strategy is obtained.

The instance allocation strategy may be configured or set in advance or in real time in the interactive interface of the federated cluster, and the instance allocation strategy may be obtained from the interactive interface of the federated cluster. The instance allocation strategy is a rule or method for allocating the required number of instances in the selected sub-clusters. The instance allocation strategy may be an average allocation, a random allocation, a weight shuffling allocation, etc.

In step 205, an instance allocation number of each of the at least two sub-clusters is determined according to the instance allocation strategy and the instance requirement number.

The instance allocation number of each sub-cluster may be one or more.

In step 206, a stateful application controller is created for each of the at least two sub-clusters.

Specifically, the command line tool provided by the container orchestration platform can be called to create a stateful application controller for each sub-cluster based on the application configuration file. One sub-cluster corresponds to one stateful application controller, and each stateful application controller manages the resources and instances of the corresponding sub-cluster.

In step 207, an instance start identifier of the corresponding sub-cluster is determined according to the instance requirement number and the instance allocation number of each of the at least two sub-clusters.

The instance allocation order of the sub-clusters can be determined according to practical requirements, and the instance start identifier of the corresponding sub-cluster can be determined according to the instance allocation order, the instance requirement number and the instance allocation number of each sub-cluster. If the instance allocation order of the sub-cluster is the first, that is, an instance start identifier is required to be allocated to the sub-cluster first, and the instance start identifier of the sub-cluster is 0; if the instance allocation order of the sub-cluster is not the first, an instance start identifier of the sub-cluster will not be 0, and the instance start identifier of the sub-cluster can be an instance end identifier of the previous sub-cluster plus 1.

For example, the sub-cluster A and the sub-cluster B are selected from the sub-clusters of the federated cluster, the instance requirement number is five, the instance allocation number of the sub-cluster A is two, and the instance allocation number of the sub-cluster B is three, and the instance allocation order is the sub-cluster A first and the sub-cluster B second; then the instance start identifier configured for the controller of the sub-cluster A can be Pod-0, and the instance start identifier configured for the controller of the sub-cluster B can be Pod-2.

In step 208, a corresponding instance start identifier and a corresponding instance allocation number are configured for the stateful application controller of each of the at least two sub-clusters.

That is, when the instance identifier configured for the controller is the instance start identifier, the instance allocation number of the corresponding sub-cluster can also be configured for the controller, to enable the controller to determine the instance identifier that each pod instance to be created by it should have according to the instance start identifier and the instance allocation number.

In step 209, a persistent identifier of each pod instance is determined by using the stateful application controller according to the configured instance start identifier and instance allocation number.

The persistent identifier of each pod instance will be unique, that is, pod instances in different sub-clusters have different persistent identifiers. For any controller, when determining the persistent identifier of the current pod instance it has created, the controller can determine whether the current pod instance is the first pod instance. If the current pod instance is the first pod instance, the instance start identifier of the controller is assigned to the current pod instance; if the current pod instance is not the first pod instance (for example, is the second or third pod instance), the persistent identifier of the previous pod instance of the current pod instance can be increased by 1, and an instance identifier obtained by increasing by 1 is used as the persistent identifier of the current pod instance.

In step 210, by using the stateful application controller, the respective pod instance is created in the corresponding sub-cluster and the respective pod instance is bound to the corresponding persistent identifier.

The controller can query the specification of the controller objects in the application configuration information to obtain the pod template. The controller can create a pod instance in the corresponding sub-cluster according to the pod template, and use the instance start identifier and instance allocation number owned by the controller itself to name the created pod instance.

Continuing with the previous example, in a case where the instance start identifier configured for the controller of the sub-cluster A is Pod-0 and the instance allocation number is two, the controller of the sub-cluster A can create two pod instances, and use Pod-0 as the persistent identifier of the first pod instance, and use Pod-1 as the persistent identifier of the second pod instance; in a case where the instance start identifier configured for the controller of the sub-cluster B is Pod-2 and the instance allocation number is three, the controller of the sub-cluster B can create three pod instances, and use Pod-2 as the persistent identifier of the first pod instance, use Pod-3 as the persistent identifier of the second pod instance, and use Pod-4 as the persistent identifier of the third pod instance.

In step 211, a container image of the target application is obtained from the application configuration information.

The container image of the target application is a packaged file that contains application code, runtime environment, dependencies and configuration files. It is an independent, portable software unit that can be deployed and run on a containerized platform. The container image is built by using a containerizer (such as Docker). It is generally based on a base image that provides a basic file system and running environment of the operating system. Based on this, applications and other dependencies are added to the image to form the final container image. The container image provides application portability, simplifies application deployment and maintenance, ensures isolation between the application and the host system, and provides higher security.

In step 212, the container image is deployed in the pod instances.

In step 213, a pod instance is created according to the conventional method.

A pod instance is created according to the conventional method, that is, do not control the instance start identifiers of different sub-clusters, and the instance start identifier of each sub-cluster is the default identifier 0.

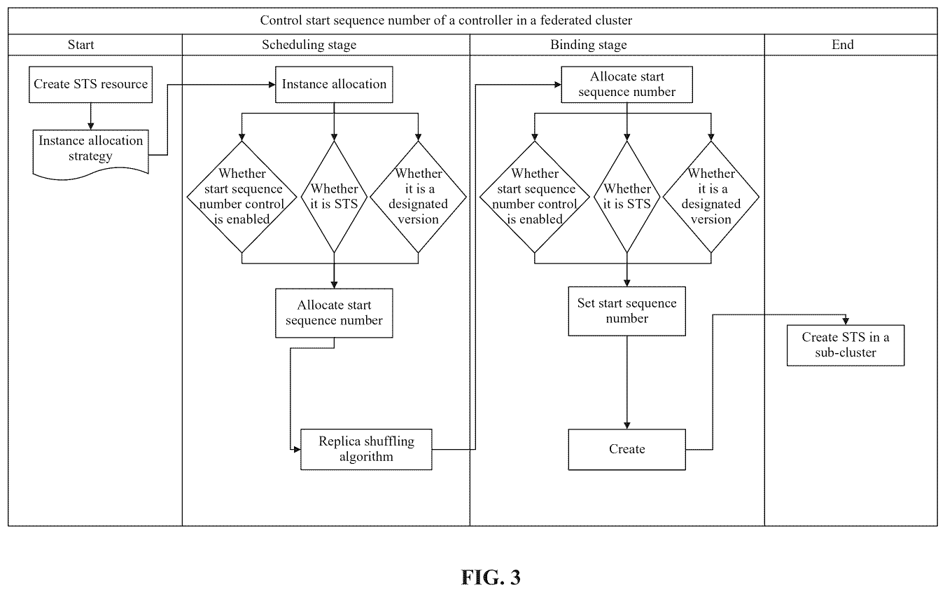

The method for creating pod instances in a federated cluster according to an embodiment of the present disclosure, as shown in FIG. 3, can be divided into four stages. In the initial stage, the created STS resources and instance allocation strategy can be obtained. The STS resources are application configuration information, and the STS resources are converted into structured data. In the scheduling stage, it can identify whether the resource type is StatefulSet, whether the StatefulSet is of a designated version, and whether the start sequence number control is enabled. If the resource type is StatefulSet, the StatefulSet is of a designated version, and the start sequence number control is enabled, then the instance start identifier of the corresponding sub-cluster is determined according to the instance requirement number and the instance allocation number of each of the at least two sub-clusters, and the instance start identifier and instance allocation number of the sub-cluster are configured to the corresponding controller, and then the STS resource is converted from structured data back to unstructured data to meet the data structure requirements of the StatefulSet native method. In the binding stage, it can identify again whether the resource type is StatefulSet, whether the StatefulSet is of a designated version, and whether the start sequence number control is enabled. If the resource type is StatefulSet, the StatefulSet is of a designated version, and the start sequence number control is enabled, then the controller is used to add a persistent identifier to the pod instance created by it. In the end stage, the pod instance is created in the selected sub-cluster by using StatefulSet.

In the solution of this embodiment, application configuration information of a target application may be acquired, and an instance requirement number of the target application may be determined according to the application configuration information; at least two sub-clusters may be selected from sub-clusters included in the federated cluster, and an instance allocation number of each of the at least two sub-clusters may be determined according to the instance requirement number; a controller may be created for each of the at least two sub-clusters, and at least one instance identifier may be configured for the controller of the corresponding sub-cluster according to the instance requirement number and the instance allocation number of each of the at least two sub-clusters, where instance identifiers configured for controllers of different sub-clusters are different; and a pod instance may be created in the corresponding sub-cluster by using the controller according to the configured at least one instance identifier. According to the present disclosure, in creating a controller for each sub-cluster, at least one instance identifier can be configured for the controller of the corresponding sub-cluster according to the instance requirement number of the application and the instance allocation number of each sub-cluster, that is, configuring an instance identifier for the controller of each sub-cluster from a global perspective to ensure that different instance identifiers are configured for the controllers of different sub-clusters. In this way, when the controller is used to create a pod instance in the corresponding sub-cluster, the instance identifier of the pod instance will fall within the range of the at least one instance identifier configured for the corresponding controller, so that the pod instances in different sub-clusters can be ensured to have different instance identifiers, which avoids the pod instances in different sub-clusters having the same instance identifier, and ensures that the application can be deployed or run in a defined order.

In addition, at least two sub-clusters are selected from the sub-clusters included in the federated cluster in real time and the instance allocation number of each sub-cluster is determined, which can enhance the flexibility of application deployment or running and improve cluster resource utilization; and by configuring different instance identifiers for the controllers of different sub-clusters, it is ensured that the pod instances in different sub-clusters have different instance identifiers, which avoids the pod instances in different sub-clusters having the same instance identifier, and since it simply requires to make configuration for the controllers, the management and operation and maintenance of application instances in the federated cluster can be simplified.

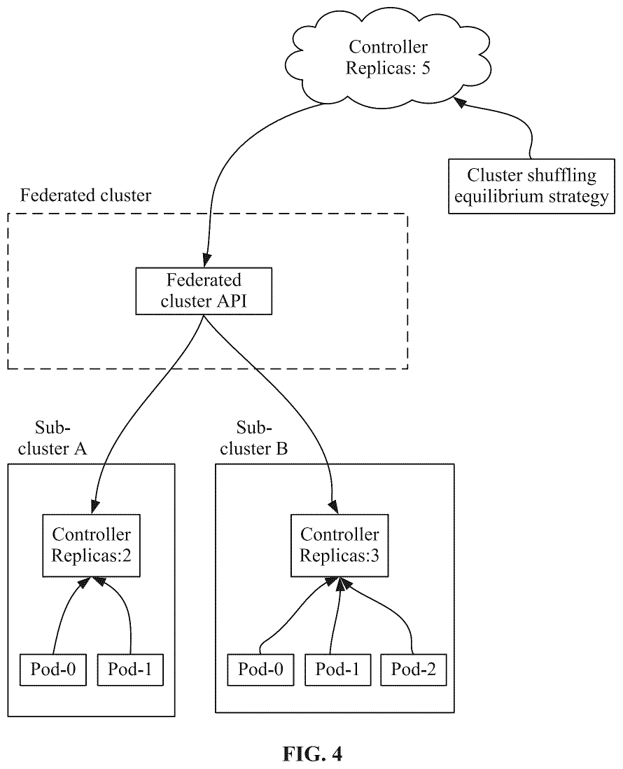

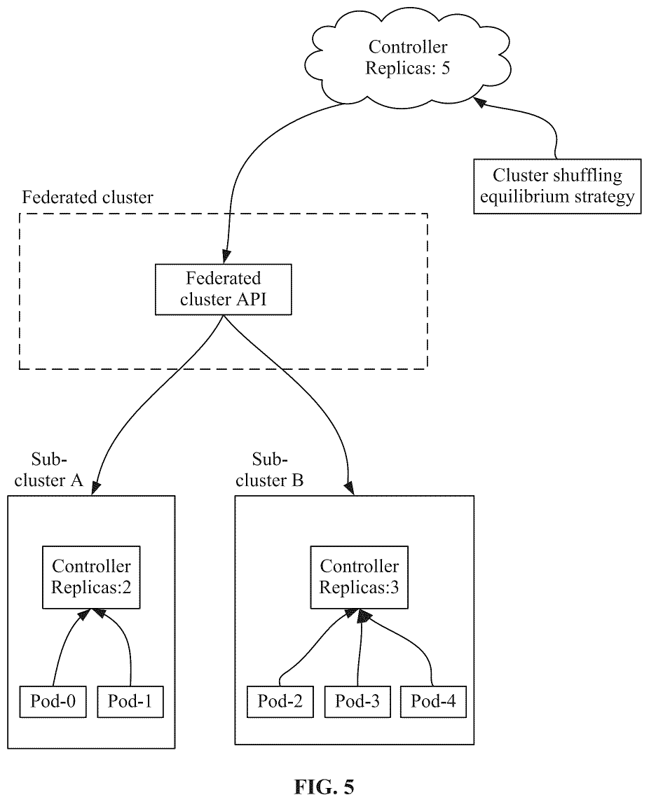

The following is an example to compare not controlling the starting sequence number of the controller with controlling the starting sequence number of the controller in the federated cluster and illustrate the difference therebetween. If a stateful application is to be deployed in the federated cluster, the sub-cluster A and the sub-cluster B are selected from the sub-clusters of the federated cluster, the instance requirement number of the application is five, the instance allocation number of the sub-cluster A is two, and the instances allocation number of the sub-cluster B is three. As shown in FIG. 4, if the start sequence numbers of the controllers of the sub-clusters are not controlled, the controller of the sub-cluster A will name the pod instances under its name as Pod-0 and Pod-1, and the controller of the sub-cluster B will name the pod instances under its name as Pod-0, Pod-1, and Pod-2. It can be seen that the pod instances in the sub-cluster A and the sub-cluster B have the same name. As shown in FIG. 5, if the method according to the embodiments of the present disclosure is used to control the start sequence numbers of the controllers of the sub-clusters, the controller of the sub-cluster A will name the pod instances under its name as Pod-0 and Pod-1, and the controller of the sub-cluster B will name the pod instances under its name as Pod-2, Pod-3 and Pod-4. It can be seen that the pod instances in the sub-cluster A and the sub-cluster B do not have the same name.

FIG. 6 is a schematic structural diagram of an apparatus for creating pod instances in a federated cluster according to an embodiment of the present disclosure. As shown in FIG. 6, the apparatus includes: a requirement determination module 601, an instance allocation module 602, a controller creation module 603 and a pod instance creation module 604.

The requirement determination module 601 is configured to acquire application configuration information of a target application, and determine an instance requirement number of the target application according to the application configuration information.

The instance allocation module 602 is configured to select at least two sub-clusters from sub-clusters included in the federated cluster, and determine an instance allocation number of each of the at least two sub-clusters according to the instance requirement number.

The controller creation module 603 is configured to create a controller for each of the at least two sub-clusters, and configure at least one instance identifier for the controller of the corresponding sub-cluster according to the instance requirement number and the instance allocation number of each of the at least two sub-clusters, where instance identifiers configured for controllers of different sub-clusters are different.

The pod instance creation module 604 is configured to create a pod instance in the corresponding sub-cluster by using the controller according to the configured at least one instance identifier.

In one embodiment, the instance allocation module 602 is further configured to: before select at least two sub-clusters from the sub-clusters comprised in the federated cluster,
identify an application type of the target application and identify whether a function of globally configuring instance identifiers is enabled; and
in a case where the application type is a stateful application and the function of globally configuring instance identifiers is enabled, select at least two sub-clusters from the sub-clusters comprised in the federated cluster.

In one embodiment, the controller creation module 603 creating a controller for each of the at least two sub-clusters, includes:
creating a stateful application controller for each of the at least two sub-clusters.

In one embodiment, the controller creation module 603 configuring at least one instance identifier for the controller of the corresponding sub-cluster according to the instance requirement number and the instance allocation number of each of the at least two sub-clusters, includes:
determining an instance start identifier of the corresponding sub-cluster according to the instance requirement number and the instance allocation number of each of the at least two sub-clusters; and
configuring a corresponding instance start identifier and a corresponding instance allocation number for the controller of each of the at least two sub-clusters.

In one embodiment, the pod instance creation module 604 is specifically configured to:
determining a persistent identifier of each pod instance by using the controller according to the configured instance start identifier and instance allocation number; and
by using the controller, creating the respective pod instance in the corresponding sub-cluster and binding the respective pod instance to the corresponding persistent identifier.

In one embodiment, the apparatus further includes:
an application deployment module, configured to obtain a container image of the target application from the application configuration information and deploy the container image in the pod instances.

In one embodiment, the instance allocation module 602 determining an instance allocation number of each of the at least two sub-clusters according to the instance requirement number, includes:
obtaining an instance allocation strategy; and
determining an instance allocation number of each of the at least two sub-clusters according to the instance allocation strategy and the instance requirement number.

The person skilled in the art can clearly understand that for the convenience and simplicity of description, the division of the above-described functional modules is simply taken as an example for illustration. In practical application, the above-described function may be allocated to different functional modules to perform according to requirements, that is, the internal structure of the apparatus may be divided into different functional modules to complete all or part of the functions described above. For the specific working processes of the functional modules described above, reference may be made to the corresponding processes in the method embodiments described above, which will not be repeated here.

In the apparatus of the embodiments of the present disclosure, application configuration information of a target application may be acquired, and an instance requirement number of the target application may be determined according to the application configuration information; at least two sub-clusters may be selected from sub-clusters included in the federated cluster, and an instance allocation number of each of the at least two sub-clusters may be determined according to the instance requirement number; a controller may be created for each of the at least two sub-clusters, and at least one instance identifier may be configured for the controller of the corresponding sub-cluster according to the instance requirement number and the instance allocation number of each of the at least two sub-clusters, where instance identifiers configured for controllers of different sub-clusters are different; and a pod instance may be created in the corresponding sub-cluster by using the controller according to the configured at least one instance identifier. According to the present disclosure, in creating a controller for each sub-cluster, at least one instance identifier can be configured for the controller of the corresponding sub-cluster according to the instance requirement number of the application and the instance allocation number of each sub-cluster, that is, configuring an instance identifier for the controller of each sub-cluster from a global perspective to ensure that different instance identifiers are configured for the controllers of different sub-clusters. In this way, when the controller is used to create a pod instance in the corresponding sub-cluster, the instance identifier of the pod instance will fall within the range of the at least one instance identifier configured for the corresponding controller, so that the pod instances in different sub-clusters can be ensured to have different instance identifiers, which avoids the pod instances in different sub-clusters having the same instance identifier, and ensures that the application can be deployed or run in a defined order.

In addition, at least two sub-clusters are selected from the sub-clusters included in the federated cluster in real time and the instance allocation number of each sub-cluster is determined, which can enhance the flexibility of application deployment or running and improve cluster resource utilization; and by configuring different instance identifiers for the controllers of different sub-clusters, it is ensured that the pod instances in different sub-clusters have different instance identifiers, which avoids the pod instances in different sub-clusters having the same instance identifier, and since it simply requires to make configuration for the controllers, the management and operation and maintenance of application instances in the federated cluster can be simplified.

An electronic device is further provided according to embodiments of the present disclosure, which includes a memory, a processor, and a computer program stored in the memory and executable on the processor. The processor, when executing the program, implements the method for creating pod instances in a federated cluster as described in any embodiment of the present disclosure.

A computer-readable medium is further provided according to embodiments of the present disclosure, which stores a computer program. The computer program, when being executed by a processor, implements a method for creating pod instances in a federated cluster as described in any embodiment of the present disclosure.

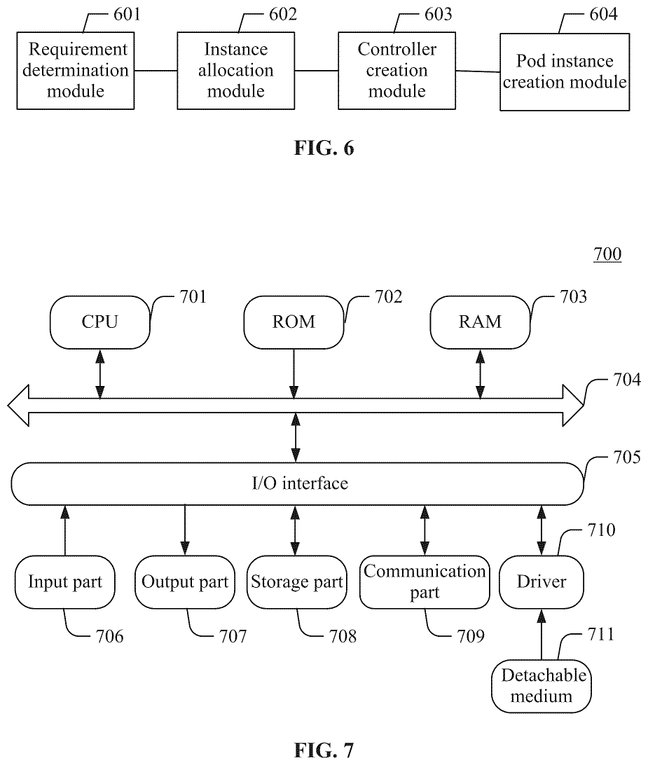

Reference is made to FIG. 7 below, which shows a schematic structural diagram of a computer system 700 suitable for implementing an electronic device of an embodiment of the present disclosure. The electronic device shown in FIG. 7 is merely an example and does not limit the function and scope of use of the present disclosure.

As shown in FIG. 7, the computer system 700 includes a central processing unit (CPU) 701, which can perform various appropriate actions and processes according to a program stored in a read-only memory (ROM) 702 or a program loaded from a storage part 708 to a random access memory (RAM) 703. Various programs and data required for the operation of the computer system 700 are also stored in the RAM 703. The CPU 701, the ROM 702 and the RAM 703 are connected to each other via a bus 704. An input/output (I/O) interface 705 is also connected to the bus 704.

The following components are connected to the I/O interface 705: an input section 706 including a keyboard, a mouse, etc.; an output section 707 including a cathode ray tube (CRT), a liquid crystal display (LCD), etc., and a speaker, etc.; a storage section 708 including a hard disk, etc.; and a communication section 709 including a network interface card such as a LAN card, a modem, etc. The communication section 709 performs communication processing via a network such as the Internet. A drive 710 is also connected to the I/O interface 705 according to requirements. A removable medium 711, such as a magnetic disk, an optical disk, a magneto-optical disk, a semiconductor memory, etc., is installed on the drive 710 according to requirements so that a computer program read therefrom is installed into the storage section 708 according to requirements.

Particularly, the embodiment disclosed according to the present disclosure, the process described above with reference to the flowchart may be implemented as a computer software program. For example, the embodiments disclosed in the present disclosure include a computer program product. The computer program product includes a computer program carried in a computer-readable medium. The computer program includes program codes for performing the method shown in the flowchart. In such an embodiment, the computer program may be downloaded and installed from the network through the communication section 709, and/or installed from the detachable medium 711. When the computer program is executed by the CPU 701, the above functions defined in the system of the present disclosure are performed.

It is to be noted that the computer-readable medium shown in the present disclosure may be a computer-readable signal medium or a computer-readable storage medium or any combination thereof. The computer-readable storage medium, for example, may be, but is not limited to, an electronic, magnetic, optical, electromagnetic, infrared or semiconductor system, apparatus or device or any combination thereof. More specific examples of the computer-readable storage medium may include, but are not limited to, an electrical connection with one or more wires, a portable computer magnetic disk, a hard disk, a random-access memory (RAM), a read-only memory (ROM), an erasable programmable read-only memory (EPROM or a flash memory), an optical fiber, a portable compact disc read-only memory (CD-ROM), an optical memory device, a magnetic memory device, or any appropriate combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal on a baseband or propagated as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or in conjunction with an instruction execution system, apparatus, or device. The program codes included on the computer-readable medium may be transmitted via any appropriate medium which includes, but is not limited to, a wire, an optical cable, a radio frequency (RF), or any appropriate combination thereof.

The flowcharts and block diagrams in the drawings show the possibly implemented architecture, function and operation of the system, method and computer program product according to various embodiments of the present disclosure. In this regard, each block in the flowcharts or block diagrams may represent a module, a program segment, or part of codes that contains one or more executable instructions for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams or flowcharts and a combination of blocks in the block diagrams or flowcharts may be implemented by a specific-purpose hardware-based system which performs specified functions or operations or a combination of specific-purpose hardware and computer instructions.

The modules and/or units described in the present disclosure may be implemented in software or in hardware. The modules and/or units described may also be set in a processor, for example, may be described as: a processor including a requirement determination module, an instance allocation module, a controller creation module, and a pod instance creation module. The names of these modules do not, in some cases, constitute limitations on the modules themselves.

As another aspect, a computer-readable medium is further provided according to the present disclosure, which may be included in the device described in the above embodiment; or it may exist independently without being assembled into the device. The computer-readable medium carries one or more programs. The one or more programs, when being executed by a device, causes the device to implement:
acquire application configuration information of a target application, and determine an instance requirement number of the target application according to the application configuration information; select at least two sub-clusters from sub-clusters included in the federated cluster, and determine an instance allocation number of each of the at least two sub-clusters according to the instance requirement number; create a controller for each of the at least two sub-clusters, and configure at least one instance identifier for the controller of the corresponding sub-cluster according to the instance requirement number and the instance allocation number of each of the at least two sub-clusters, where instance identifiers configured for controllers of different sub-clusters are different; and create a pod instance in the corresponding sub-cluster by using the controller according to the configured at least one instance identifier.

In the technical solution of the present disclosure, application configuration information of a target application may be acquired, and an instance requirement number of the target application may be determined according to the application configuration information; at least two sub-clusters may be selected from sub-clusters included in the federated cluster, and an instance allocation number of each of the at least two sub-clusters may be determined according to the instance requirement number; a controller may be created for each of the at least two sub-clusters, and at least one instance identifier may be configured for the controller of the corresponding sub-cluster according to the instance requirement number and the instance allocation number of each of the at least two sub-clusters, where instance identifiers configured for controllers of different sub-clusters are different; and a pod instance may be created in the corresponding sub-cluster by using the controller according to the configured at least one instance identifier. According to the present disclosure, in creating a controller for each sub-cluster, at least one instance identifier can be configured for the controller of the corresponding sub-cluster according to the instance requirement number of the application and the instance allocation number of each sub-cluster, that is, configuring an instance identifier for the controller of each sub-cluster from a global perspective to ensure that different instance identifiers are configured for the controllers of different sub-clusters. In this way, when the controller is used to create a pod instance in the corresponding sub-cluster, the instance identifier of the pod instance will fall within the range of the at least one instance identifier configured for the corresponding controller, so that the pod instances in different sub-clusters can be ensured to have different instance identifiers, which avoids the pod instances in different sub-clusters having the same instance identifier, and ensures that the application can be deployed or run in a defined order.

In addition, at least two sub-clusters are selected from the sub-clusters included in the federated cluster in real time and the instance allocation number of each sub-cluster is determined, which can enhance the flexibility of application deployment or running and improve cluster resource utilization; and by configuring different instance identifiers for the controllers of different sub-clusters, it is ensured that the pod instances in different sub-clusters have different instance identifiers, which avoids the pod instances in different sub-clusters having the same instance identifier, and since it simply requires to make configuration for the controllers, the management and operation and maintenance of application instances in the federated cluster can be simplified.

It should be understood that the various forms of processes shown above can be used to reorder, add or delete steps. For example, the steps described in the present disclosure can be executed in parallel, sequentially or in different orders, as long as the desired results of the technical solution of the present disclosure can be achieved, which is not limited herein.

It should be noted that in the technical solution of the present disclosure, the acquisition, collection, update, analysis, processing, use, transmission, storage and other aspects of user personal information involved are in compliance with the provisions of relevant laws and regulations, are used for legal purposes, and do not violate public order and good morals. Necessary measures are taken for user personal information to prevent illegal access to user personal information data and maintain user personal information security, network security and national security.

What is claimed is:

1. A method for creating container group pod instances in a federated cluster, comprising:
acquiring application configuration information of a target application, and determining an instance requirement number of the target application according to the application configuration information;
selecting at least two sub-clusters from sub-clusters comprised in the federated cluster, and determining an instance allocation number of each of the at least two sub-clusters according to the instance requirement number;
creating a controller for each of the at least two sub-clusters, and configuring an instance identifier for a controller of a corresponding sub-cluster according to the instance requirement number and the instance allocation number of each of the at least two sub-clusters, wherein instance identifiers configured for controllers of different sub-clusters are different; and
creating a pod instance in the corresponding sub-cluster by using the controller according to configured instance identifiers.

2. The method according to claim 1, before the selecting at least two sub-clusters from sub-clusters comprised in the federated cluster, further comprising:
identifying an application type of the target application and identifying whether a function of globally configuring instance identifiers is enabled; and
in a case where the application type is a stateful application and the function of globally configuring instance identifiers is enabled, triggering a performance of selecting at least two sub-clusters from the sub-clusters comprised in the federated cluster.

3. The method according to claim 2, wherein the creating a controller for each of the at least two sub-clusters comprises:
creating a stateful application controller for each of the at least two sub-clusters.

4. The method according to claim 1, wherein the configuring an instance identifier for a controller of a corresponding sub-cluster according to the instance requirement number and the instance allocation number of each of the at least two sub-clusters comprises:
determining an instance start identifier of the corresponding sub-cluster according to the instance requirement number and the instance allocation number of each of the at least two sub-clusters; and
configuring a corresponding instance start identifier and a corresponding instance allocation number for the controller of each of the at least two sub-clusters.

5. The method according to claim 4, wherein the creating a pod instance in the corresponding sub-cluster by using the controller according to configured instance identifiers comprises:
determining a persistent identifier of each pod instance by using the controller according to the configured instance start identifier and instance allocation number; and
by using the controller, creating the pod instance in the corresponding sub-cluster and binding the pod instance to the corresponding persistent identifier.

6. The method according to claim 1, further comprising:
obtaining a container image of the target application from the application configuration information; and
deploying the container image in the pod instances.

7. The method according to claim 1, wherein the determining an instance allocation number of each of the at least two sub-clusters according to the instance requirement number comprises:
obtaining an instance allocation strategy; and
determining an instance allocation number of each of the at least two sub-clusters according to the instance allocation strategy and the instance requirement number.

8. An electronic device, comprising a memory, a processor, and a computer program stored in the memory and executable on the processor, wherein the processor, when executing the program, implements a method for creating container group pod instances in a federated cluster;
wherein the method comprises:
acquiring application configuration information of a target application, and determining an instance requirement number of the target application according to the application configuration information;
selecting at least two sub-clusters from sub-clusters comprised in the federated cluster, and determining an instance allocation number of each of the at least two sub-clusters according to the instance requirement number;
creating a controller for each of the at least two sub-clusters, and configuring an instance identifier for a controller of a corresponding sub-cluster according to the instance requirement number and the instance allocation number of each of the at least two sub-clusters, wherein instance identifiers configured for controllers of different sub-clusters are different; and
creating a pod instance in the corresponding sub-cluster by using the controller according to configured instance identifiers.

9. The electronic device according to claim 8, wherein before the selecting at least two sub-clusters from sub-clusters comprised in the federated cluster, the method further comprises:
identifying an application type of the target application and identifying whether a function of globally configuring instance identifiers is enabled; and
in a case where the application type is a stateful application and the function of globally configuring instance identifiers is enabled, triggering a performance of selecting at least two sub-clusters from the sub-clusters comprised in the federated cluster.

10. The electronic device according to claim 9, wherein the creating a controller for each of the at least two sub-clusters comprises:
creating a stateful application controller for each of the at least two sub-clusters.

11. The electronic device according to claim 8, wherein the configuring an instance identifier for a controller of a corresponding sub-cluster according to the instance requirement number and the instance allocation number of each of the at least two sub-clusters comprises:
determining an instance start identifier of the corresponding sub-cluster according to the instance requirement number and the instance allocation number of each of the at least two sub-clusters; and
configuring a corresponding instance start identifier and a corresponding instance allocation number for the controller of each of the at least two sub-clusters.

12. The electronic device according to claim 11, wherein the creating a pod instance in the corresponding sub-cluster by using the controller according to configured instance identifiers comprises:
determining a persistent identifier of each pod instance by using the controller according to the configured instance start identifier and instance allocation number; and
by using the controller, creating the pod instance in the corresponding sub-cluster and binding the pod instance to the corresponding persistent identifier.

13. The electronic device according to claim 8, wherein the method further comprises:
obtaining a container image of the target application from the application configuration information; and
deploying the container image in the pod instances.

14. The electronic device according to claim 8, wherein the determining an instance allocation number of each of the at least two sub-clusters according to the instance requirement number comprises:
obtaining an instance allocation strategy; and
determining an instance allocation number of each of the at least two sub-clusters according to the instance allocation strategy and the instance requirement number.

15. A non-transitory computer-readable storage medium, storing a computer program, wherein the computer program, when being executed by a processor, implements a method for creating container group pod instances in a federated cluster;
wherein the method comprises:
acquiring application configuration information of a target application, and determining an instance requirement number of the target application according to the application configuration information;
selecting at least two sub-clusters from sub-clusters comprised in the federated cluster, and determining an instance allocation number of each of the at least two sub-clusters according to the instance requirement number;
creating a controller for each of the at least two sub-clusters, and configuring an instance identifier for a controller of a corresponding sub-cluster according to the instance requirement number and the instance allocation number of each of the at least two sub-clusters, wherein instance identifiers configured for controllers of different sub-clusters are different; and
creating a pod instance in the corresponding sub-cluster by using the controller according to configured instance identifiers.

16. The non-transitory computer-readable storage medium according to claim 15, wherein before the selecting at least two sub-clusters from sub-clusters comprised in the federated cluster, the method further comprises:
identifying an application type of the target application and identifying whether a function of globally configuring instance identifiers is enabled; and
in a case where the application type is a stateful application and the function of globally configuring instance identifiers is enabled, triggering a performance of selecting at least two sub-clusters from the sub-clusters comprised in the federated cluster.

17. The non-transitory computer-readable storage medium according to claim 15, wherein the configuring an instance identifier for a controller of a corresponding sub-cluster according to the instance requirement number and the instance allocation number of each of the at least two sub-clusters comprises:
determining an instance start identifier of the corresponding sub-cluster according to the instance requirement number and the instance allocation number of each of the at least two sub-clusters; and
configuring a corresponding instance start identifier and a corresponding instance allocation number for the controller of each of the at least two sub-clusters.

18. The non-transitory computer-readable storage medium according to claim 17, wherein the creating a pod instance in the corresponding sub-cluster by using the controller according to configured instance identifiers comprises:
determining a persistent identifier of each pod instance by using the controller according to the configured instance start identifier and instance allocation number; and
by using the controller, creating the pod instance in the corresponding sub-cluster and binding the pod instance to the corresponding persistent identifier.

19. The non-transitory computer-readable storage medium according to claim 15, wherein the method further comprises:
obtaining a container image of the target application from the application configuration information; and
deploying the container image in the pod instances.

20. The non-transitory computer-readable storage medium according to claim 15, wherein the determining an instance allocation number of each of the at least two sub-clusters according to the instance requirement number comprises:
obtaining an instance allocation strategy; and
determining an instance allocation number of each of the at least two sub-clusters according to the instance allocation strategy and the instance requirement number.
